(19) United States
(12) Patent Application Publication
(10) Pub. No.: US 2002/0154349 A1
(43) Pub. Date: Oct. 24, 2002

(54) Holographic display screen and method for producing the screen

(75) Inventors: Thorsteinn Halldorsson, Muenchen (DE); Hannes Lucas, Zaisertshofen (DE); Horst Schmidt-Bischoffshausen, Neubiberg (DE)

Correspondence Address: FASSE PATENT ATTORNEYS, P.A., P.O. BOX 726, HAMPDEN, ME, 04444-0726, US

(73) Assignee: EADS Deutschland GmbH, Muenchen (DE)

(21) Appl. No.: 10/165,452

(22) Filed: Jun. 7, 2002

Related U.S. Application Data
(63) Continuation-in-part of application No. 09/367,136, filed on Aug. 6, 1999, now abandoned.

(30) Foreign Application Priority Data
Feb. 7, 1997 (DE) 197 04 740.8

(51) Int. Cl. G02B 5/32; G03H 1/04

(52) U.S. Cl. 359/15; 359/35

(57) ABSTRACT

A transparent holographic display screen for laser projection of at least one or more monochromatic wavelengths, is constructed to selectively diffuse an incident narrow-band laser beam at a predetermined solid angle and simultaneously to pass wide-band ambient light unobstructed through the display screen. The transparent holographic display screen has at least one holographic volume phase grating which is optically coupled to or integrated with a transparent carrier plate. The holographic display screen with its volume grating is produced by illuminating a real screen as an object into a primary hologram and recording a real holographic image of said real screen into a secondary hologram.

### CROSS-REFERENCE TO RELATED APPLICATION

This application is a Continuation-In-Part of copending U.S. patent application Ser. No. 09/367,136, filed on Feb. 3, 1999 as a CPA Application of U.S. PCT Application 09/367,136, filed on Aug. 6, 1999.

### FIELD OF THE INVENTION

The invention relates to the production and use of a transparent holographic projection display screen as a display device in land vehicles, water craft and flying aircraft or the simulation thereof.

### BACKGROUND INFORMATION

The data which are displayed for the driver of a vehicle, for example an automobile, or for the pilot flying an aircraft, may roughly be divided into two categories. The first category of data includes information about the actual operation and technical condition of important individual systems, such as fuel quantity, pressures, temperatures, RPMs, mode of operation and so forth. The second category of data includes information which serves for the locomotion, navigation, and target acquisition and includes speed, elevation, attitude, location, direction, and so forth.

It is expected that in the near future the quantity as well as the variety of the available actual data in both categories will increase. There will be available further actual data regarding the technical condition of the motor vehicle such as the tire pressure and regarding the braking system or in an aircraft regarding an ice formation on the wings, flow separation, and material fatigue. Further, improved data will be provided regarding the destination, distance, road conditions, traffic jams, collision dangers, the most advantageous route and weather conditions.

The development of passenger aircraft during the last 30 years has seen a continuous increase in information data. However, that increase did not lead to an increased demand on the pilot. To the contrary the automation of many aircraft functions led to an improved data management and an improved information display. Thus, for example the radio officer and the on-board engineer became obsolete. During the last 10 years a further development commenced in the form of a variable display of the aircraft status and of flying data on displays which were able to replace a substantial number of the rigid indicator instruments in so-called glass cockpits. This development took place in addition to the increasing use of computers in the operation of aircraft and in the piloting of aircraft. The advantage of such glass cockpit displays is seen in that the display only occurs when it is needed. The pilot can call up the display or it appears automatically in critical situations.

A similar development is to be expected for motor vehicles, that is the classical fixed display instruments for fuel, oil pressure, engine temperature, RPM, kilometers or miles driven and the speed will be replaced by a common display which either automatically or in response to a call-up displays the actual or required information without delay. A number of further, computed information data will be available in vehicles in the near future such as stopping distance under prevailing road conditions, spacings to other vehicles on the road or to obstacles while parking, traffic guidance information and so forth. Such information data will have to be displayed on a universal display instrument.

The technical requirements which will have to be met by a future universal display instrument in a vehicle are primarily the following: an improved visibility even under very bright background conditions e.g. in broad daylight. An improved color display, a higher contrast, and a finer image resolution will also be required. Furthermore, it will be necessary that the location of the display on the image screen as well as its size, shape, and brightness are continuously variable.

A disadvantage of conventional indicators in use today in a dashboard below the outward viewing field of the pilot or driver through the windshield, is seen in that the indicator can be read or viewed only by nodding the head downwardly for viewing the indicator display in the near field or close range. In addition to this interruption of the observation of the surroundings through the windshield, which interruption constitutes a substantial obstacle to the viewing especially when driving a vehicle, the eye must newly accommodate between the two observations and find its way in a changed scene which can lead to accidents.

For some time new display methods for combat aircraft are being developed and partially used in the field which relieved the pilot in that the display is faded as a virtual image into his viewing field or viewing direction through the cockpit window. A virtual image has the advantage that it appears in infinity whereby no accommodation of the eye or only a small accommodation change is required for the viewing. This is a substantial advantage in the rapidly changing scene of a low flying combat aircraft where the pilot must make rapid decisions while the instrument indications vary continuously. The virtual display is projected either on a transparent glass pane in front of the windshield or into spectacles in the helmet worn by the pilot.

The displays generated by a monochromic CRT screen are produced by a narrow band reflector which reflects only the wavelength of the display screen and which passes the wide band light through the windshield or from displays in the instrument panel. The imaging optics are simultaneously so designed, that the display of the screen in the viewing field of the pilot appears as a virtual image. Display arrangements of this type are referred to as head-up displays (HUDs) and are for example described in the following publications: M. H. Freeman, Head-up Displays-A Review. Optics Technology, February 1969, pp 63-70 and R. J. Withrington, “Optical Design of a Holographic Visor Helmet-Mounted Displays, Computer Aided Optical Design”, Proc. SPIE Vol. 14, pp. 161-170.

Efforts are also known to integrate HUDs into the windshield of passenger cars: W. Windeln, M. A. Beeck “Windschutzscheibe mit Holographischem Spiegel fuer Head-Up Displays”, ATZ “Automobiltechnische Zeitschrift” 91 (1989) Vol. 10, pp. 2-6. A display system preferably for motor vehicles is described in German Patent Publication DE 3,712,663 A1 relating to a “display system for the reading of information, as much as possible free of accommodation, when the eye is adjusted to distant viewing”. The system presents the information to be displayed as virtual image in the windshield or in the area of the dashboard.

These experiments and suggestions to transfer the HUD technology from its use in combat aircraft into a car, however require, just as the conventional display technology used in aircraft, the use of image generators such as CRT and LCD monitors with the same limitations regarding low brightness, limited resolution and weak gray scale values as well as limited color contrast. Another disadvantage of the prior art is seen in that it can display only monochromic green images which eliminates the possibility of a differentiated information formation by means of colors. Further problems of the conventional head-up displays are the limited viewing angle of only up to about 20° and the unstable motion of the image when rapid head motions are made.

The foregoing disadvantages of the prior art are due to the fact that the conventionally constructed HUDs constitute a color selective mirror, which is realized in the HUD as a diffractive structure. The image on the monitor (CRT or LCD) which is seen after magnification by a lens optics and deflection by this mirror through the window as an image in the far distance. Since the mirror reflects selectively only the green light of the wavelength of the recording laser of the hologram, which corresponds to the color of the monitor, the largest proportion of the ambient light passes unhindered through the hologram.

Because of these functions the image magnification and displacement as a virtual image far away from the observer can be performed by conventional HUDs only in a narrow viewing angle range of about 10° to 20° HUDs remained limited to the use in combat aircraft. In a passenger aircraft and a motor vehicle a relatively wide viewing or observation angle is required in order that the copilot, for example, or the co-driver can also notice the display. Additionally a display over the width of the outer window or windshield would be of great advantage in this context. from another publication: “Handbook of Optical Holography” by H. J. Caulfield, pages 373 to 378, published “Academic Press” in 1979 it is known how to generally copy holograms. The real image of a hologram is used as an object for the recording of a second hologram, whereby the image plane of the real image is positioned outside of the plane of the second hologram.

### OBJECTS AND SUMMARY OF THE INVENTION

In connection with an improved HUD technology that could also be used in passenger aircraft, motor vehicles, boats, ships, and other observation needs such as simulation training centers observation displays and the like, the invention aims at achieving the following objects or requirements, such as: small weight, small installation depth, resistance against vibrations and accelerations for the intended mobile operation, utilization of the maximal display surface, readability within a wide viewing angle within a range of about 30° to about 60°, wherein “about” covers ±5° unless several holograms are assembled side-by-side to obtain even larger viewing angles. A maximal surface area utilization due to an undivided display surface, a central display of critical information, variable sequential or superimposed displays of many informations, color selectivity capabilities, at least 4 million image pixels per display, for a resolution of about 0.5 angular minutes, image frame frequency of at least 100 Hz are also aims or objects of the invention. Still another object is a new transparent, holographic display screen positioned preferably in front or integrated into the windshield in the viewing field of the pilot or driver and which satisfies the above requirements and is useable as an improved HUD in the above application fields. Still another object of the invention is that a laser image projector as a point source, projects a real image on the holographic display screen.

For satisfying these requirements which in part cannot be realized by a CRT display nor by an LCD display, the invention uses preferably one or more of the special characteristics of laser projection. These characteristics are first, a small laser line width with a resulting large coherence length. Second, laser projectors have a high beam density, that is, a high light power per solid angle, and surface area unit. The first characteristic can be used for the efficient separation of multi-color laser light from extraneous light. The second characteristic enables an image projection with a high resolution and a large brightness and contrast even under bright surrounding light conditions. A third feature is the color quality of the summation of the three monochromatic laser lines in the selected wavelength range. Such color quality is not achievable with conventional methods. However, the invention is not limited to the use of laser light as a projection tool. Other monochromatic or polychromatic light sources such as light emitting diodes, LEDs or spectral lamps with distinguished line spectra are also suitable for the projection purposes of the invention. These other light sources are considered to be point light sources which, in this context, are small light sources other than a CRT or LCD light source, which have a substantial size.

According to the invention there is provided a method for producing a transparent holographic display screen for displaying information with a display projection light beam emanating from a display projector, said method comprising the following steps:

(a) preparing a transparent carrier plate for passing wide band ambient light through said transparent carrier plate,

(b) producing a primary volume hologram by recording a real projection display screen as an object of said primary volume hologram, and using an object beam and a divergent reference beam for said recording,

(c) producing a real image of said real projection display screen of said primary volume hologram by illuminating said primary volume hologram with a reproduction beam,

(d) producing a secondary volume hologram by recording said real image of said real projection display screen of said primary hologram as an object of said secondary volume hologram, in the plane of the said secondary volume hologram (in-plane-hologram), and

(e) optically integrating or coupling said secondary volume hologram with said transparent carrier plate to form said holographic display screen as a see through holographic display screen.

According to the invention there is further provided a transparent holographic display screen for displaying information with a projection laser light beam emanating from a display laser projector, said transparent display screen comprising a transparent carrier plate for passing wide band ambient light through said transparent carrier plate, a secondary volume hologram optically integrated with said transparent carrier plate, said secondary volume hologram comprising a holographic volume phase grating representing a real image of a real display screen as an interference pattern, wherein said real image of said real display screen is a record in the plane of the secondary hologram of an object of a primary volume hologram produced with a divergent reference beam.

The invention uses instead of a monochromatic mirror, as in a conventional HUD, the above defined transparent holographic projection display screen as an object hologram which is produced so that it displays a real image for the viewer when it is illuminated by incident display laser light or other monochromatic or polychromatic light or by a display beam from a backlight projector, while passing wide band light coming in through a window thereby leaving the view through that window toward the outside free. This is a very important advantage of the invention compared to displays that project an area hologram onto a conventional dashboard, thereby forcing the viewer to look down so that he can, at least momentarily, not look out through the windshield. The present transparent holographic display screen is optimized so that it selectively diffracts the narrow band laser light in one or several colors with a high efficiency in the color selectivity in a defined solid angle while substantially transmitting unaffected the broad band ambient light. As an object hologram this new technique provides the special advantage that a large image display surface can be illuminated while simultaneously making available a wide viewing angle within the range of about 30° to 60° or even larger than 60° if several holograms are positioned side-by-side. Additionally a sharp contrast and high resolutions are achieved in combination with a high brightness display.

The object of this holographic image screen is preferably an adapted white real display screen which is recorded as a volume hologram that is then coupled to or integrated with or incorporated in a transparent carrier plate. The recording preferably takes place with all utilized laser projection wavelengths. During the recording care is taken that the transparent holographic display screen is illuminated with or exposed to the object beam of said real display screen in such a way that the beam diffraction- or scattering characteristic is the same as is required in the later actual use of the screen. A spread-out divergent beam bundle serves as a reference beam during the holographic recording. The divergent reference beam emanates from a location corresponding to that from which later the projection beam emanates. The hologram is preferably recorded as an off-axis volume hologram whereby the recording beam is incident on the hologram surface at an angle relative to the normal of the hologram surface, which angle is sufficiently large to provide a free view through the hologram without shading caused by the projector.

Depending on the type of use it is preferred that the projector is positioned in a location in front of or behind the transparent holographic display screen, where the divergent reference beam emanated during the recording of the volume hologram. It depends on the position or location of the projector whether the hologram is produced as a reflection hologram with an incident light projection or as a transmission hologram with a backlight projection. For the information display with the aid of the volume hologram either a widened image projection beam, or a point scanning beam, or a line scanning beam can be used as the display projector beam. These types of projection beams are all intended to be covered by the term “point light source” as used herein.

For this purpose all projection methods known today may be used. For example the light valve principle may be used in which an image matrix is projected with laser illumination onto a screen by micro mirrors (digital mirror device, DMD), or by liquid crystal devices in a fixed-in-space projection beam. The serial image projection by laser scanners is also useable whereby the image is built-up point by point or line by line.

The volume hologram is optically coupled to or forms part of or is integrated in a transparent carrier plate in optical contact with the transparent carrier plate, for example a glass plate. The holographic display screen will appear transparent the same as the carrier plate under a real illumination with a broad band ambient light. The carrier plate is preferably provided with an antireflection coating to prevent reflections.

If the surface area of the transparent holographic display screen is illuminated or scanned by a laser beam out of the correct illumination direction, that is, from the location of the source of the earlier fixed divergent reference beam, the original image of the screen is built up again image point by image point in parallel or serially. If the projection beam is additionally modulated with image data, the image is generated for the viewer in the recording layer as if it would appear on the original screen, however with the above outlined improvements according to the invention.

However care must be taken that during the recording and the reproduction or projection the same or approximately the same laser lines or wavelengths are being used and that the projection emanates from the same point as the divergent reference beam during the recording of the hologram. For assuring a high image quality care must be taken that the expansion of the image source, as seen from the screen, corresponds approximately to a point laser source. This last requirement is always satisfied by a scanning system. In connection with an imaged image matrix having a diagonal of 20 mm and a projection distance of 200 mm the size of the image source is 6°, which may have an influence on the quality of the image. Since the matrix is illuminated with a bundled laser radiation, a scale reduction of the source is easily realized by an intermediate imaging under 1° which very nearly approximates a point source.

In order to achieve the required angular selectivity and wavelength selectivity for a reflection hologram it is necessary that the transparent holographic display screen has the characteristics of a volume hologram. This is preferably achieved by a recording of a volume hologram by reflection or transmission into one or several “thick” recording layers of about 5 to 30 micrometer in thickness integrated with or optically coupled to a transparent carrier plate. Several volume phase grating structures are produced by the recording and processing of the hologram as a real image of a real display screen independently of one another for the different wavelengths used. Under the so-called BRAGG-interference-condition of the grating structure, which is satisfied each time only for one wavelength and one illumination angle, the light is reflected back or diffracted and a light image of the real display screen with its original scattering characteristic appears when viewing the transparent holographic display screen. This repeats itself for other discrete wavelengths with their allocated phase grating structures within the same layer or further layers to form a heterodyned total picture which represents, when correct color coordination is present, the real image of the original white real projection display screen. Light of other wideband wavelengths is substantially passed through undiminished due to the missing accordance with the BRAGG conditions provided it is not incident out of the direction of the laser projection. Stray light that does not fall into the +1 diffraction order, such as proportions of the zero order and first order light, is not reflected back but passes through the hologram where it is easily blanked out.

While it is possible to use “thick” as well as “thin” transmission holograms for the observation of transmitted light, the use of “thick” or volume holograms is preferred according to the invention. The decision which type should be used depends on the available recording materials, their costs, the desired diffraction efficiency and the type of reproduction. However, a large viewing angle, an excellent color or wavelength selectivity and contrast selectivity can be achieved particularly with thick or volume holograms in combination with the high brightness achieved with laser projection light.

According to the invention it is suggested that the volume hologram of the holographic image screen is produced in two steps. The first step is the same as above described to produce a primary volume hologram with an object beam and a divergent reference beam. However, here instead of using the virtual image of a real display screen, the real image of a real holographic display screen of the first recording is used as object for recording a secondary hologram to thereby optimize the recording. This use of the first or primary volume hologram for producing as the object for the recording of the secondary hologram has the advantage that the position of the image of the transparent holographic display screen during reproduction or display can be adjusted to be in the plane of the secondary hologram, for example in or behind a windshield as seen by a viewer sitting behind the windshield and looking in the travel direction. The term “behind the windshield” means inside a vehicle.

Various optical elements such as lenses, curved mirrors or holographic optical elements may be installed into the beam path of the real image of a real display screen. These elements vary the image of the screen in the secondary hologram, for example by enlargement. The term “vehicle” includes any conveyance.

After the production of the transparent holographic display screen additional optical imaging elements such as lenses, curved mirrors or holographic optical elements may be integrated into the beam path to the viewer. These elements vary the image geometrically, for example by enlargement or scale reduction.

A white holographic real projection display screen is, as explained above, preferably prepared by incorporating a screen with all the used laser wave lengths for example red, green and blue (RGB) into the same hologram. In this connection there are three different realization possibilities. First, three exposures of all colors into one recording layer on the carrier plate may be performed. Second, several layers of different spectral sensitivities may be stacked on the carrier plate and adapted to the different laser wavelengths. Third, the different recording materials can be arranged on the carrier plate next to each other, for example in punctiform as RGB-triple within each image point in a triangular arrangement in the manner of the phosphors arranged in a television delta shadow mask tube or as three neighboring vertical RGB strips in the manner of the phosphors in the known television trinitron tube.

In a stack construction of the layers on the transparent carrier plate, for example three different recording materials may be used which are adapted to the colors. In the case using three laterally arranged layers for the different colors it is possible to additionally suppress the color “cross talk” as in a cathode ray tube.

The invention further provides that “thick” or volume transmission holograms are used for the recording of the screen particularly in applications in which a high selectivity of the hologram with regard to the reproduction wavelength and the beam incidents direction is of advantage.

In thick holograms a volume phase grating is formed during the recording in the recording layer having, as a rule, a thickness in the range of 5 to 30 micrometer. Due to the interference between neighboring partial beams which are phase shifted relative to each other the BRAGG-condition applies during reproduction for the constructive interference. Thus, a strong diffraction efficiency for the recording wavelength and the illumination direction of the reference beam are integrated into the screen and wide-band light passes for the most part unhindered through the screen.

As in a “thin” hologram, in the volume hologram either several recordings of the screen for different colors can be made in the same hologram layer or in different hologram layers arranged in a row or next to each other with an adapted color sensitivity.

It is possible to influence the holographic image of the screen in reflection holograms and in transmission holograms by the installation of additional optical elements into the beam paths of the divergent reference beam or of the object beam. Thereby, it is for example possible to vary the angle of radiation of the holographic screen relative to the original screen with regard to elevation and azimuth. Further, the brightness distribution over the screen can be adjusted differently and image faults of the projection optics can be subsequently corrected.

Recording materials for the “thin” holograms are for example suitably selected from silver halogenate materials or photo resist materials. Silver halogenate materials, dichromate gelatine or photo polymer materials are preferred for the “thick” or volume holograms.

The production of the present transparent holographic display screens for front projection and rear projection with lasers has been described above by way of example. The production can however be performed in a multitude of different ways and with different steps which are known to the person of ordinary skill in the art at the time the invention was made and which are understood.

### BRIEF DESCRIPTION OF THE DRAWINGS

The invention will now be described in more detail in the following with reference to example embodiments shown in part schematically in the accompanying drawings, wherein:

FIG. 1 shows the direct recording of a reflection master hologram of an object screen which is a real display screen, whereby a divergent reference beam is used;

FIG. 2 shows the recording of a transmission master hologram of an object screen which is a real projection display screen, whereby a divergent reference beam is used;

FIG. 3A shows the first step of the recording of a transmission master hologram of a real projection display screen;

FIG. 3B shows the second step of said recording by illuminating the transmission master by the conjugated beam, thereby generating the real image which is recorded by the secondary hologram;

FIG. 4 shows the observation of a reflection or front projection holographic display screen in operation recorded according to FIG. 3B; and

FIG. 5 shows three examples of locating the virtual image of the present display relative to a windshield.

### DETAILED DESCRIPTION OF PREFERRED EXAMPLE EMBODIMENTS AND OF THE BEST MODE OF THE INVENTION

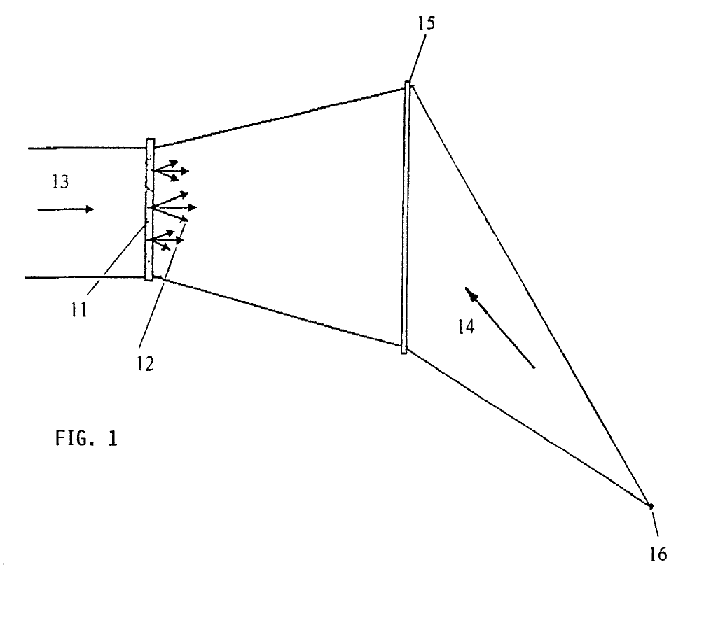

FIG. 1 shows the recording of a reflection master hologram 15 of a real transmission screen 11. Diffusively scattered object light 12 of an object beam 13 passing forwardly out of the object real display screen 11 is superimposed or heterodyned with the light of a diverging reference beam 14 emanating from a point source 16. The divergent reference beam 14 from the point light source 16 impinges from the opposite side on a holographic film 15 namely opposite the object light 12. The illumination of the real display screen 11 takes place preferably from the back, whereby, for example, advantages are achieved relative to the light intensity of the arrangement.

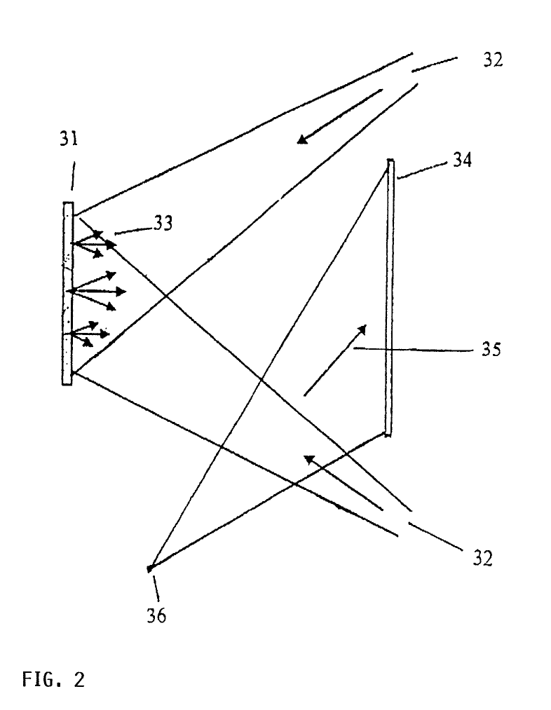

FIG. 2 shows the recording of a transmission master hologram 34 of a reflecting projection display screen 31. Recording light 32 illuminates the object real screen 31 from several directions. Back scattered light 33 from the real screen 31 is superimposed on the divergent reference beam 35 in a volume hologram 34. The divergent reference beam 35 emanates from a point light source at a location 36.

Holographic image screens can be recorded with the above described methods as reflection volume holograms or as transmission volume holograms. The object, i.e. the real screen, is recorded into a primary hologram which is then used according to the invention for a production of a secondary hologram. As is known to a person of ordinary skill in this art at the time when the invention was made, it is possible to copy the primary hologram in order to produce further so-called primary holograms which produce real images of the screen. The primary hologram is now used in a second step for producing the secondary hologram or holograms. For this purpose, the primary hologram is illuminated with a conjugated reference beam in order to reconstruct the real image of the real display screen. That real image is positioned in the plane of the secondary hologram when the secondary hologram is produced. This two-step method widens the possibilities of advantageously influencing the characteristics of the transparent holographic display screen relative to the position of the virtual image, the stray characteristic and the brightness distribution in the display.

The real display screen recorded into the primary hologram need not be plane. Rather, any desired 3-dimensional surface structure or shape can be used. For special projections, for example curved or vaulted holographic screens can be of advantage. If the real image of a curved or vaulted real screen is recorded into the secondary hologram, a curved or vaulted secondary volume hologram adapted to the real image is preferably used.

The installation of optical additional elements in the beam path of the divergent reference beam and/or the object beam makes it possible to influence the holographic image of the screen, for example with regard to the brightness distribution of the reproduction for display, with regard to the spacial radiation characteristic, or with regard to the targeted correction of image faults which occurred during the projection.

Instead of recording master or primary holograms by using interference optics, it is possible to use computer generated holograms, or holograms produced by computer generated holograms, in which a certain scattering function has been entered by computation. In view of the above it is to be understood that the holographic screen for the HUD according to the invention can be used for one or more laser lines or wave length. These laser lines need not necessarily be part of the visible spectrum. Rather, they may be in the UV or IR range when suitable recording materials are used for the recording of images with technical sensors such as cameras, photo detectors or photo detector arrays.

Although high requirements are made with regard to the spectral narrow band characteristic or timely coherence of the illumination source for the recording of the real display screen, the reproduction can be performed by using light sources with individual sharp spectral lights such as lasers, gas discharge lamps, filtered wide band discharge lamps such as halogen lamps or glow lamps.

In addition, the present holographic display screen can also be used as a so-called helmet mounted display (HMD) where it is installed into the open spectacles of the helmet and illuminated from the side in a front projection or a rear projection.

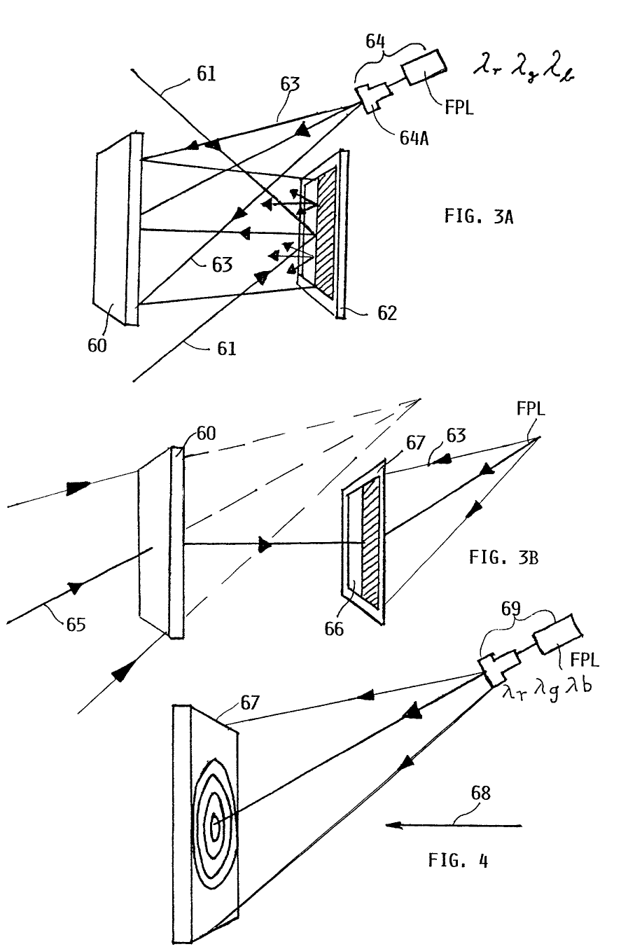

FIGS. 3A and 3B show in detail the two steps for recording a holographic reflection or front projection display screen according to the invention. The first step shown in FIG. 3A illustrates the recording of a transmission volume primary master hologram 60 from a real diffusion screen 62 as the object. Prior to the recording the primary hologram 60 is a transparent carrier plate with the necessary photographic coatings suitable for the recording of a volume hologram. An object beam 61 projected onto the real diffusion screen 62 is reflected by the real diffusion screen 62 onto the transparent carrier plate which becomes the primary hologram 60. A divergent reference beam 63 is projected onto the primary hologram 60 by a reference beam laser projector 64 having an objective 64A. According to the invention the reference beam laser projector 64 is positioned in a fixed projector location FPL and emits the divergent reference beam 63.

The second recording step shown in FIG. 3B illustrates the recording of the holographic reflection display screen 67 having recorded therein a real image 66 of the real diffusion screen 62. In this second step, the real image 66 is used as an object. The recording is performed by a conjugate recording reference beam 65 through the transmission volume primary hologram 60 to form the secondary holographic display screen 67 as a real image of the diffusion screen 62. The divergent reference beam 63 emanates from the same fixed projector location FPL as in FIG. 3A.

FIG. 4 shows the projection of an image to be displayed with the help of the secondary holographic reflection display screen 67, whereby the image may be observed in the screen. According to the invention the display projector 69 is positioned in the same fixed projector location FPL as was the divergent reference beam projector 64 during the above described recording steps for making the display screen 67. An arrow 68 represents the viewing direction of an observer looking at the display screen 67, who sees a real image of the projector 69 on the plane of the screen 67.

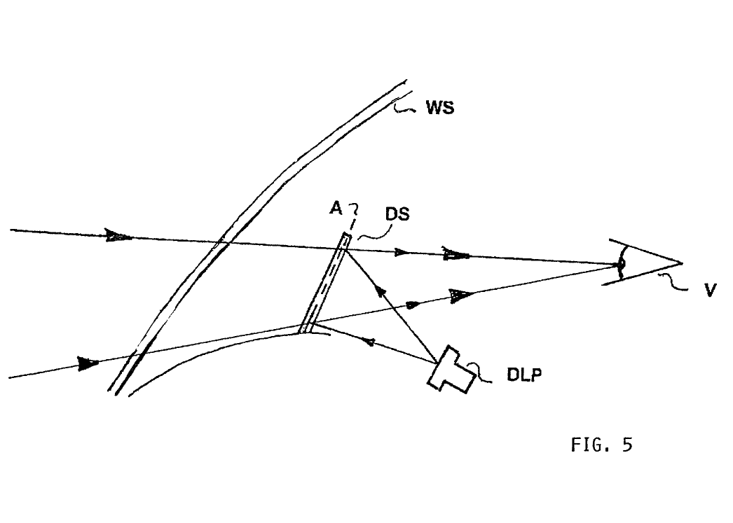

FIG. 5 shows schematically a practical example embodiment of the invention. A windshield WS, a transparent holographic display screen DS according to the invention produced according to FIGS. 3A and 3B, a viewer V, and a display laser projector DLP are positioned, for example, inside a vehicle. The display laser projector DLP may be located in any desirable location P1 or P2 including overhead locations not shown provided these locations are the same as that of the divergent reference beam projector in FIG. 3A. Optical devices not shown may be positioned in the beam path between the display laser projector DLP and the display screen.

The position of the real image A is located inside the vehicle in the travel direction in front of the windshield WS at some distance from the viewer V. Optical devices, not shown, may be used to accommodate any inclination angle of the windshield WS.

Position A is the preferred position of the projection of the real image on the screen D at a fixed distance. The distance between the viewer V may be freely selected to minimize eye accommodation, which is an important advantage of the invention.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A method for producing a transparent holographic display screen for displaying information with a display projection light beam emanating from a display projector, said method comprising the following steps:
(a) preparing a transparent carrier plate for passing wide band ambient light through said transparent carrier plate,
(b) producing a primary volume hologram by recording a real projection display screen as an object of said primary volume hologram, and using an object beam and a divergent reference beam for said recording,
(c) producing a real image of said real projection display screen of said primary volume hologram by illuminating said primary volume hologram with a reproduction beam,
(d) producing a secondary volume hologram by recording said real image of said real projection display screen of said primary hologram as an object of said secondary volume hologram, wherein said real image is positioned in the plane of said secondary volume hologram, and
(e) optically integrating said secondary volume hologram with said transparent carrier plate to form said holographic display screen as a see through holographic display screen.

2. The method of claim 1, further comprising positioning a source of a divergent reference beam in a fixed location for producing said primary volume hologram as one of a transmission volume hologram and a reflection volume hologram.

3. The method of claim 1, further comprising positioning optical elements in a recording beam path of a divergent reference beam emanating from a source positioned in a fixed location for correcting a brightness distribution and image faults during producing said primary volume hologram.

4. The method of claim 1, further comprising positioning optical imaging elements into a beam path of a holographic image reproduced from said primary volume hologram for optically varying said holographic image while producing said secondary volume hologram.

5. The method of claim 1, further comprising the step of using said transparent holographic display screen in a head-up display and producing a display by projecting monochromatic light onto said transparent holographic display screen from a point light source.

6. The method of claim 1, wherein said recording of said real display screen as defined in step (b) is performed by using at least two or more laser sources with different colors, and wherein the beams of said laser sources are brought into the same optical path.

7. The method of claim 1, wherein said recording of said real display screen as defined in step (b) is performed with different colors to form a polychromatic master volume hologram.

8. The method of claim 1, wherein said recording of said real display screen as defined in step (b) is performed with different colors to form different monochromatic master volume holograms.

9. A transparent holographic display screen for displaying information with a projection light beam emanating from a display projector, said transparent holographic display screen comprising a transparent carrier plate for passing wide band ambient light through said transparent carrier plate, a secondary volume hologram optically integrated with said transparent carrier plate, said secondary volume hologram comprising a holographic volume phase grating in which a real image of a real display screen is optically stored as an interference pattern, wherein said real image of said real display screen is a reproduction of said real display screen optically stored in a primary volume hologram and generated from said primary volume hologram by a conjugate reference beam, said real image of said real display screen being in the plane of said secondary hologram.

10. The transparent holographic display screen of claim 9, wherein said holographic volume phase grating is a holographic reflection volume phase grating.

11. The transparent holographic display screen of claim 9, wherein said holographic volume phase grating is a holographic transmission volume phase grating.

12. The transparent holographic display screen of claim 9, wherein said transparent carrier plate comprises an antireflection coating.

13. The transparent holographic display screen of claim 9, wherein said holographic volume phase grating comprises one holographic volume phase grating for each of three primary colors.

14. The transparent holographic display screen of claim 13, comprising three holographic volume phase gratings positioned in a single layer in said secondary volume hologram.

15. The transparent holographic display screen of claim 13, comprising three holographic volume phase gratings positioned in a plurality of layers in said secondary volume hologram.

16. The transparent holographic display screen of claim 9, wherein said holographic volume phase grating comprises a plurality of different holographic layers arranged next to one another, and wherein each of said different holographic layers reflects one primary color, and wherein said different holographic layers are integrated into said transparent carrier plate.

17. The transparent holographic display screen of claim 9, wherein said holographic volume phase grating comprises a transmission volume hologram and a reflection volume hologram positioned in front of said transmission volume hologram in the direction toward a viewer, said reflection volume hologram reflecting back stray light out of said transmission volume hologram.

18. The transparent holographic display screen of claim 17, wherein said volume reflection hologram is constructed as a holographic mirror for directionally reflecting any stray radiation.

19. The transparent holographic display screen of claim 17, wherein said reflection volume hologram is constructed as a reflector for diffusively reflecting any stray radiation.

20. The transparent holographic display screen of claim 9, wherein said transparent holographic display screen has a viewing angle within the range of about 30° to about 60°.

21. The transparent holographic display screen of claim 9, further comprising a display projector light source positioned for producing images on said transparent holographic display screen by serial point scanning with a modulated image beam.

22. The transparent holographic display screen of claim 9, further comprising a display projector light source positioned for producing images on said transparent holographic display screen by parallel line scanning with a modulated image line.

23. The transparent holographic display screen of claim 9, further comprising a display projector light source including a light valve modulator for producing images on said transparent holographic display screen by projecting an areal, space fixed image matrix onto said transparent holographic display screen.

24. The transparent holographic display screen of claim 9, further comprising a display projector monochromatic light source including one of a narrow band light emitting diode and a laser light source positioned for projecting an image onto said transparent holographic display screen.

25. The transparent holographic display screen of claim 9, further comprising a spectrally filtered wide band lamp forming a monochromatic display projector light source positioned for projecting an image onto said transparent holographic display screen.

26. The transparent holographic display screen of claim 9, further comprising a laser light source for providing a display projector laser beam.

27. The transparent holographic display screen of claim 26, wherein said laser light source is a point light source.
